(19) United States
(12) Patent Application Publication
(10) Pub. No.: US 2024/0233225 A1
(43) Pub. Date: Jul. 11, 2024

(54) IMAGE GENERATION DEVICE

(71) Applicant: JVCKENWOOD Corporation, Yokohama-shi (JP)

(72) Inventors: Atsushi SAITO, Yokohama-shi (JP); Takahiro HAYASHI, Yokohama-shi (JP); Miku KOMURATA, Yokohama-shi (JP)

(21) Appl. No.: 18/610,048

(22) Filed: Mar. 19, 2024

Related U.S. Application Data
(63) Continuation of application No. PCT/JP2022/010317, filed on Mar. 9, 2022.

(30) Foreign Application Priority Data
Sep. 24, 2021 (JP) 2021-155726

(51) Int. Cl. G06T 11/60

(52) U.S. Cl. CPC G06T 11/60

(57) ABSTRACT

The present invention is to adjust a stereoscopic effect of at least one of a moving image and a still image to make it difficult to fatigue a viewer. An image generation device includes a fatigue data acquisition unit that acquires fatigue data indicating information on fatigue of a viewer, a parallax adjustment value data acquisition unit that calculates parallax adjustment value data including a parallax adjustment value on the basis of the fatigue data, and a parallax adjustment unit that adjusts a parallax of an image on the basis of the parallax adjustment value,

### CROSS REFERENCE TO RELATED APPLICATION

The present invention relates to an image generation device.

Priority is claimed on Japanese Patent Application No. 2021-155726, filed Sep. 24, 2021, the content of which is incorporated herein by reference.

### BACKGROUND

A moving image or still image displayed on a display may affect a function of an autonomic nervous system of a viewer and fatigue the viewer. For example, a three-dimensional virtual reality (VR) video may not provide a sense of protrusion, depth, or the like that is desirable for the viewer, and may cause fatigue of the viewer depending on a degree of parallax. Therefore, for example, a technology for linking an angle of the display to a video displayed on the display, measuring the distance between the pupils of the viewer from the angle of the display that allows the viewer to suitably view the image, and adjusting a video display mode depending to the distance is used.

Incidentally, this technology requires the viewer to make settings in order to adjust a video display mode, which may bother the viewer. An example of a technology for solving such a problem is a video system disclosed in Patent Document 1. This video system adjusts a parallax of the video within a range of a depth of focus of the eyes of the viewer, thereby making it difficult for the viewer to become fatigued when the viewer views the video.

### CITATION LIST

### Patent Document

[Patent Document 1] Japanese Unexamined Patent Application, First Publication No. 11-355808

### SUMMARY

### Technical Problem

However, the video system described above may fatigue the viewer even when the parallax of the video is adjusted within the range of the depth of focus of the eyes of the viewer.

The present embodiment has been made in view of the above-described circumstances, and is intended to provide an image generation device capable of adjusting a stereoscopic effect of at least one of a moving image and a still image to make it difficult for a viewer to become fatigued.

### Solution to Problem

An aspect of the present embodiment is an image generation device including: a fatigue data acquisition unit configured to acquire fatigue data indicating information on fatigue, the fatigue data including at least a fatigue degree of a viewer; a parallax adjustment value data acquisition unit configured to calculate parallax adjustment value data including a parallax adjustment value on the basis of the fatigue data; and a parallax adjustment unit configured to adjust a parallax of an image on the basis of the parallax adjustment value.

An aspect of the present embodiment is the image generation device described above, wherein the parallax adjustment value data acquisition unit acquires the parallax adjustment value data indicating the parallax adjustment value for making an amount of change in parallax of the image per unit time equal to or smaller than a predetermined amount of change when the fatigue data indicates that the fatigue degree of the viewer changes in excess of a predetermined threshold within a predetermined time.

An aspect of the present embodiment is the image generation device described above, further including: a recording unit in which the fatigue data and the parallax adjustment value data are recorded in association with each other, wherein the fatigue data acquisition unit acquires first fatigue data when a first still image in a moving image has been displayed, and acquires second fatigue data when a second still image displayed after the first still image is displayed, and the parallax adjustment value data acquisition unit acquires the first fatigue data and the second fatigue data from the fatigue data acquisition unit, acquires the parallax adjustment value data corresponding to the fatigue data from the recording unit, and adjusts a parallax of an image to be displayed, from the first acquired fatigue data and the second acquired fatigue data and the parallax adjustment value based on the parallax adjustment value data.

An aspect of the present embodiment is the image generation device described above, wherein the fatigue data acquisition unit acquires the fatigue data from each of a plurality of viewers who have viewed a still image in a moving image, and the parallax adjustment value data acquisition unit acquires the parallax adjustment value data indicating the parallax adjustment value calculated on the basis of the fatigue data acquired from each of the plurality of viewers who have viewed the still image in the moving image.

According to the present embodiment, it is possible to provide an image generation device capable of adjusting the stereoscopic effect of at least one of the moving image and the still image to make it difficult to fatigue the viewer.

### BRIEF DESCRIPTION OF THE DRAWINGS

FIG. 1 is a diagram illustrating an example of a hardware configuration of an image generation device according to an embodiment.

FIG. 2 is a diagram illustrating an example of a software configuration of the image generation device according to the embodiment.

FIG. 3 is a diagram illustrating an example of a relationship between the degree of fatigue of a viewer and a parallax adjustment value according to the embodiment.

FIG. 4 is a diagram illustrating an example of relationships between the distance between both eyes of a viewer and a display, an interval between both eyes of the viewer, a parallax of an image, and a protrusion amount of an object displayed on the display according to the embodiment.

FIG. 5 is a flowchart illustrating an example of processing executed by the image generation device according to the embodiment.

FIG. 6 is a diagram illustrating an example of a relationship between the degree of fatigue of the viewer recorded by the image generation device according to the embodiment and the protrusion amount of the object displayed on the display.

FIG. 7 is a flowchart illustrating an example of processing that the image generation device according to the embodiment executes for the first still image constituting the moving image.

FIG. 8 is a flowchart illustrating an example of processing that the image generation device according to the embodiment executes for the second still image constituting the moving image.

### DETAILED DESCRIPTION

### Embodiments

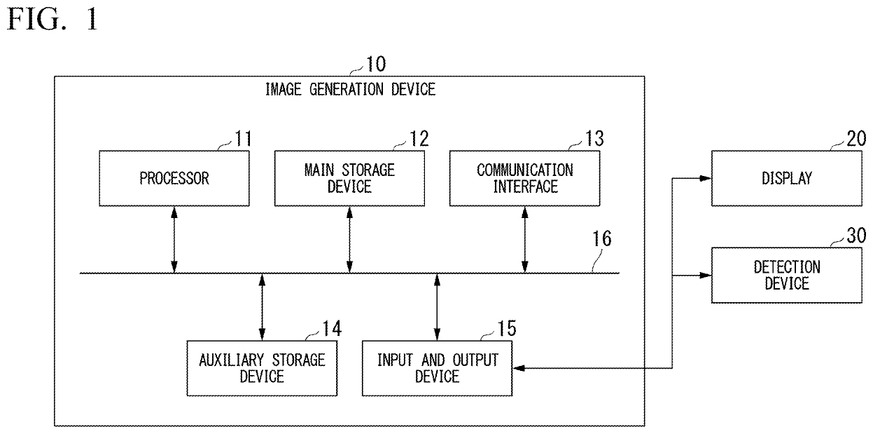

An image generation device and an image generation program according to an embodiment will be described with reference to FIGS. 1 to 8.

First, a hardware configuration of an image generation device according to an embodiment will be described with reference to FIG. 1. FIG. 1 is a diagram illustrating an example of the hardware configuration of the image generation device according to the embodiment. As illustrated in FIG. 1, the image generation device 10 includes a processor 11, a main storage device 12, a communication interface 13, an auxiliary storage device 14, an input and output device 15, and a bus 16.

The processor 11 is, for example, a central processing unit (CPU), and reads and executes the image generation program so that each function of the image generation device 10 is realized. Further, the processor 11 may read and execute a program other than the image generation program so that a function necessary for realization of each function of the image generation device 10 is realized.

The main storage device 12 is, for example, a random-access memory (RAM), and stores in advance an image generation program and other programs that are read and executed by the processor 11.

The communication interface 13 is an interface circuit for executing communication with other devices via a network. Further, the network is, for example, a wide area network (WAN), a local area network (LAN), the Internet, or an intranet.

The auxiliary storage device 14 is, for example, a hard disk drive (HDD), a solid-state drive (SSD), a flash memory, or a read only memory (ROM).

The input and output device 15 is, for example, an input/output port. A display 20 and a detection device 30, for example, are connected to the input and output device 15.

The display 20 is, for example, a liquid crystal display, and displays an image to be viewed by the viewer. Furthermore, the image referred to here may be a moving image or a still image.

The detection device 30 is a sensor that collects fatigue data indicating information on fatigue of the viewer viewing the image from the viewer. An example of such a sensor is a camera. For example, the detection device 30 films movements of the pupils of the viewer viewing the image, and generates fatigue data indicating at least one of a moving image and a still image obtained by imaging at least one of these. Furthermore, the movement of the pupil of the viewer includes, for example, at least one of a miosis and a mydriasis. The fatigue data may be stored in the auxiliary storage device 14, for example. Here, for the fatigue data based on the movement of the pupil of the viewer, change in brightness or the like of a video and change in opening of the pupils over time may be acquired and a fatigue degree indicating the degree of fatigue may be calculated and included in the fatigue data. The calculation of the fatigue degree may be performed by using a fatigue degree calculation method based on general change in pupils. Although the fatigue data based on the movement of the pupil of the viewer has been described here, any fatigue data may be used as long as the fatigue data is fatigue data based on change in biological information of the viewer. The biological information may be the movement of the pupil, a line of sight, blinking, blood pressure, pulse, brain waves, change in posture, degree of tension, and the like of the viewer.

The bus 16 connects the processor 11, the main storage device 12, the communication interface 13, the auxiliary storage device 14, and the input and output device 15 in an aspect in which these can exchange data with each other.

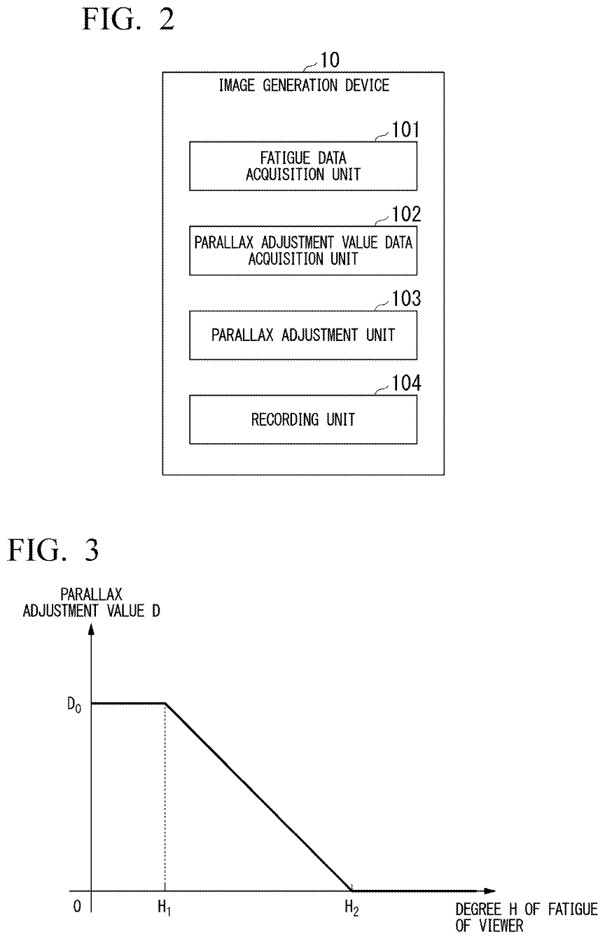

Next, a software configuration of the image generation device according to the embodiment will be described with reference to FIGS. 2 to 4. FIG. 2 is a diagram illustrating an example of the software configuration of the image generation device according to the embodiment. As illustrated in FIG. 2, the image generation device 10 includes a fatigue data acquisition unit 101, a parallax adjustment value data acquisition unit 102, a parallax adjustment unit 103, and a recording unit 104.

The fatigue data acquisition unit 101 acquires the fatigue data from at least one of the detection device 30 and the auxiliary storage device 14, for example.

The parallax adjustment value data acquisition unit 102 acquires the parallax adjustment value data indicating the parallax adjustment value that is used to adjust the parallax of the image viewed by the viewer and calculated on the basis of the fatigue data. When the parallax adjustment value is greater, the parallax of the image viewed by the viewer increases, and when the parallax adjustment value is smaller, the parallax of the image viewed by the viewer decreases. Further, the parallax adjustment value may be calculated by the parallax adjustment value data acquisition unit 102, or may be calculated by an entity other than the parallax adjustment value data acquisition unit 102.

The parallax adjustment value is calculated, for example, on the basis of at least one of a speed of the miosis and a speed of the mydriasis when the brightness of the image being viewed by the viewer has changed. This movement of the pupil is called light reflection. In addition, the parallax adjustment value calculated by using such a method is a value indicating that, when the at least one of the speed of the miosis and the speed of the mydriasis is lower, the degree of fatigue of the viewer increases and, when the at least one of the speed of the miosis and the speed of the mydriasis is higher, the degree of the fatigue of the viewer decreases. For example, this parallax adjustment value has a relationship illustrated in FIG. 3 with the degree of the fatigue of the viewer.

FIG. 3 is a diagram illustrating an example of a relationship between the degree of the fatigue of the viewer and the parallax adjustment value according to the embodiment. A horizontal axis in FIG. 3 indicates a degree H of fatigue of the viewer. A vertical axis in FIG. 3 indicates a parallax adjustment value D0. Further, the parallax adjustment value D0, a degree H1 of fatigue of the viewer and a degree H2 of fatigue of the viewer illustrated in FIG. 3 can be arbitrarily determined. A relationship between the degree of fatigue and the parallax adjustment value illustrated in FIG. 3 is expressed by Equation (1) below.

$$\begin{matrix}[ Math . 1 ] & \\ D ( H ) = \{ \begin{matrix}{D}_{0} & H < {H}_{1} \\ \frac{{D}_{0} ( {H}_{2} - H )}{{H}_{2} - {H}_{1}} & {H}_{1} < H < {H}_{2} \\ 0 & H > {H}_{2}\end{matrix} & ( 1 )\end{matrix}$$

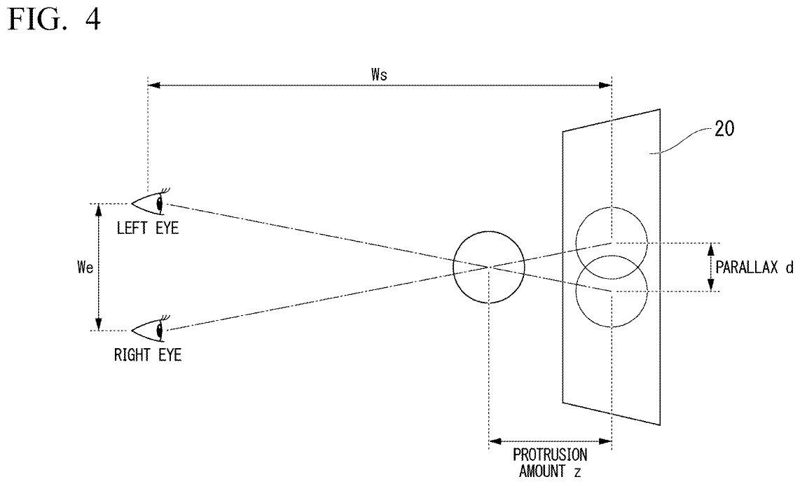

The parallax adjustment unit 103 adjusts the parallax of the image viewed by the viewer on the basis of the parallax adjustment value indicated by the parallax adjustment value data. FIG. 4 is a diagram illustrating an example of a relationship among the distance between both eyes of the viewer and the display, an interval between both eyes of the viewer, the parallax of the image, and a protrusion amount of an object displayed on the display according to the embodiment. FIG. 4 shows a distance Ws between both eyes of the viewer and the display 20, an interval We between the right eye and the left eye of the viewer, a parallax d of the image, and a protrusion amount z of the object displayed on the display 20. For example, the parallax adjustment unit 103 uses Equation (2) including the parallax adjustment value D to adjust the parallax of the image viewed by the viewer.

$$\begin{matrix}[ Math . 2 ] & \\ d ( z ) = D \times \frac{We \cdot z}{Ws - z} & ( 2 )\end{matrix}$$

Further, the parallax adjustment unit 103 may adjust the parallax of the image so that the protrusion amount of the object displayed on the display 20 becomes zero. That is, the parallax adjustment unit 103 may adjust the parallax of the image so that the image displayed on the display 20 does not have a stereoscopic effect. The image whose parallax has been adjusted by the parallax adjustment unit 103 has been displayed on the display 20.

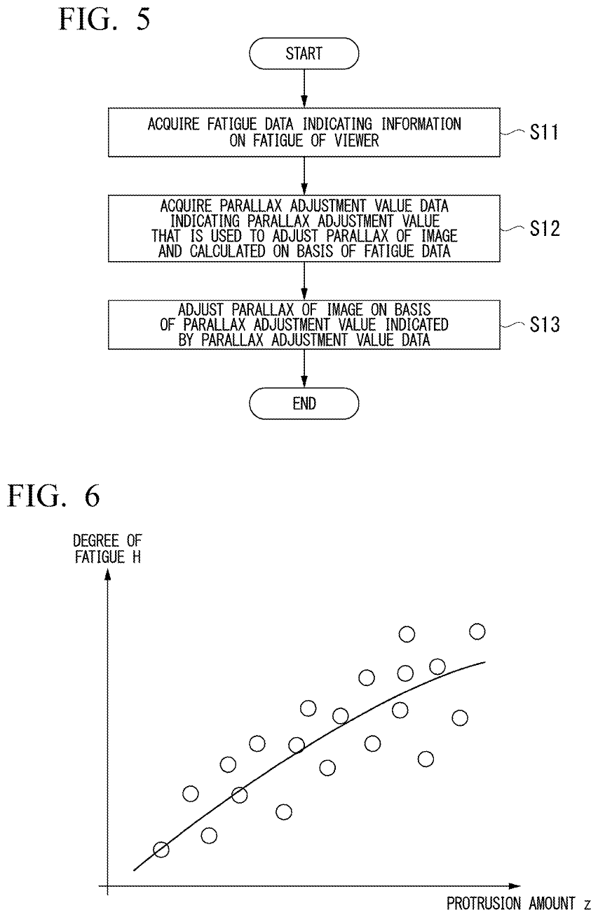

Next, an example of processing executed by the image generation device 10 according to the embodiment will be described with reference to FIG. 5. FIG. 5 is a flowchart illustrating an example of processing executed by the image generation device according to the embodiment.

In step S11, the fatigue data acquisition unit 101 acquires the fatigue data indicating the information on the fatigue of the viewer.

In step S12, the parallax adjustment value data acquisition unit 102 acquires the parallax adjustment value data indicating the parallax adjustment value that is used to adjust the parallax of the image and calculated on the basis of the fatigue data.

In step S13, the parallax adjustment unit 103 adjusts the parallax of the image on the basis of the parallax adjustment value indicated by the parallax adjustment value data.

Next, an example of other processing executed by the image generation device according to the embodiment will be described with reference to FIG. 6. The image generation device 10 executes processing to be described below when the first still image and the second still image are included in the image viewed by the viewer.

The first still image is a still image constituting a moving image viewed by the viewer. Further, the second still image is displayed on the display 20 after the first still image, which is a still image constituting the moving image. Further, for example, the first still image and the second still image are still images that are included in the moving image and constitute different scenes.

The fatigue data acquisition unit 101 acquires the fatigue data that is generated each time at least one first still image is displayed. For example, the fatigue data acquisition unit 101 acquires the fatigue data acquired by the detection device 30 when a plurality of first still images constituting a first scene included in the moving image are displayed on the display 20. Further, it is preferable for the fatigue data acquisition unit 101 to execute a process of acquiring the fatigue data generated each time at least one first still image is displayed two or more times, and to execute the process as many times as possible.

The parallax adjustment value data acquisition unit 102 acquires the parallax adjustment value data each time at least one first still image is displayed and the fatigue data is acquired by the fatigue data acquisition unit 101. This parallax adjustment value data may indicate the parallax adjustment value calculated by the parallax adjustment value data acquisition unit 102 or may indicate a parallax adjustment value calculated by an entity other than the parallax adjustment value data acquisition unit 102. For example, the parallax adjustment value data acquisition unit 102 acquires the parallax adjustment value data each time the fatigue data acquired by the detection device 30 when the plurality of first still images constituting the first scene included in the moving image are displayed on the display 20 is acquired.

The recording unit 104 records the fatigue data and the parallax adjustment value data in association with each other each time at least one first still image is displayed and the fatigue data is acquired. For example, the recording unit 104 stores the fatigue data and the parallax adjustment value data in the auxiliary storage device 14 in association with each other each time the fatigue data acquired by the detection device 30 when the plurality of first still images constituting the first scene included in the moving image are displayed on the display 20 is acquired and the parallax adjustment value data is generated on the basis of the fatigue data. Through this process, the recording unit 104 generates, for example, data indicating the relationship illustrated in FIG. 6, and stores the data in the auxiliary storage device 14.

FIG. 6 is a diagram illustrating an example of a relationship between the degree of the fatigue of the viewer recorded by the image generation device according to the embodiment and the protrusion amount of object displayed on the display. A horizontal axis in FIG. 6 indicates the protrusion amount z of the object displayed on the display 20. A vertical axis in FIG. 6 indicates the degree H of fatigue of the viewer. Points indicated by white circles in FIG. 6 are points corresponding to a pair of fatigue data and parallax adjustment value data. Further, a curve indicated by a solid line in FIG. 6 is an approximate curve calculated from the tendency of a distribution of the plurality of points indicated by the white circles in FIG. 6. This approximate curve is calculated by the parallax adjustment unit 103, for example. However, this approximate curve may be calculated by an entity other than the parallax adjustment unit 103.

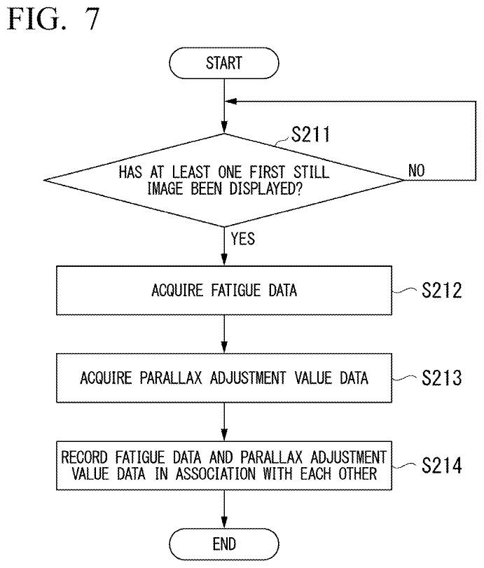

Next, an example of a process that the image generation device 10 according to the embodiment executes for the first still image constituting the moving image will be described with reference to FIG. 7. FIG. 7 is a flowchart illustrating an example of a process that the image generation device according to the embodiment executes for the first still image constituting the moving image.

In step S211, the fatigue data acquisition unit 101 determines whether at least one first still image has been displayed. When the fatigue data acquisition unit 101 determines that the at least one first still image has been displayed (step S211: YES), the process proceeds to step S212. On the other hand, when the fatigue data acquisition unit 101 determines that the at least one first still image is not displayed (step S211: NO), the fatigue data acquisition unit 101 waits until the fatigue data acquisition unit 101 determines that at least one first still image is displayed.

In step S212, the fatigue data acquisition unit 101 acquires the fatigue data.

In step S213, the parallax adjustment value data acquisition unit 102 acquires the parallax adjustment value data.

In step S214, the recording unit 104 records the fatigue data and the parallax adjustment value data in association with each other.

Next, an example of processing that the image generation device 10 according to the embodiment executes for the second still image constituting the moving image will be described.

The fatigue data acquisition unit 101 acquires the fatigue data when the at least one second still image has been displayed on the display 20. For example, the fatigue data acquisition unit 101 acquires the fatigue data acquired by the detection device 30 when a plurality of second still images forming a second scene included in a moving image are displayed on the display 20.

When the at least one second still image is displayed and fatigue data is acquired, the parallax adjustment value data acquisition unit 102 acquires parallax adjustment value data indicating a parallax adjustment value that is used to adjust a parallax of the second still image and calculated on the basis of content recorded in the recording unit 104. For example, the parallax adjustment value data acquisition unit 102 acquires the parallax adjustment value data indicating the parallax adjustment value calculated on the basis of the degree of fatigue of the viewer indicated by the fatigue data and the approximate curve indicated by the solid line in FIG. 6, in a case where the fatigue data acquired by the detection device 30 is acquired when the plurality of second still images constituting the second scene included in the moving image are displayed on the display 20. This parallax adjustment value is not a parallax adjustment value that is directly calculated from the fatigue data. Further, this parallax adjustment value may be calculated by the parallax adjustment value data acquisition unit 102, or may be calculated by an entity other than the parallax adjustment value data acquisition unit 102.

The parallax adjustment unit 103 adjusts the parallax of the image viewed by the viewer on the basis of the parallax adjustment value indicated by the parallax adjustment value data. This image may be the second still image that has not been displayed on the display 20 so far, or may be a still image constituting the moving image that has been displayed on the display 20 after the second scene. For example, the parallax adjustment unit 103 adjusts the parallax of the image to be displayed on the display 20 on the basis of the parallax adjustment value data indicating the parallax adjustment value calculated on the basis of the fatigue data acquired by the detection device 30 when the plurality of second still images are displayed on the display 20 and the approximate curve indicated by the solid line in FIG. 6 in a case where the parallax adjustment value data has been acquired.

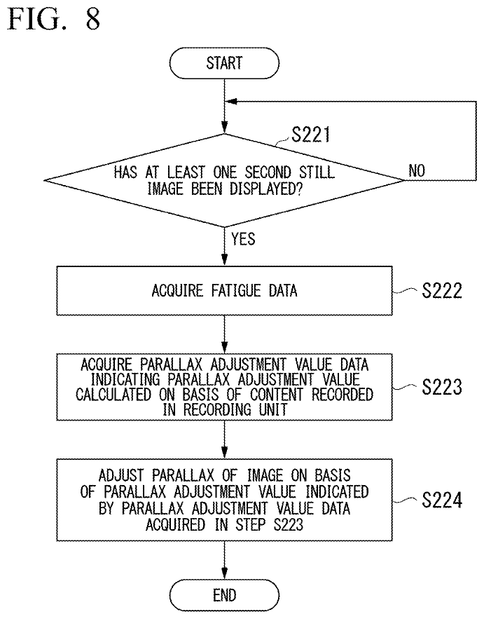

Next, an example of a process that the image generation device 10 according to the embodiment executes for the first still image constituting the moving image will be described with reference to FIG. 8. FIG. 8 is a flowchart illustrating an example of a process that the image generation device according to the embodiment executes for the second still image constituting the moving image.

In step S221, the fatigue data acquisition unit 101 determines whether the at least one second still image has been displayed. When the fatigue data acquisition unit 101 determines that the at least one second still image has been displayed (step S221: YES), the process proceeds to step S222. On the other hand, when the fatigue data acquisition unit 101 determines that the at least one second still image has not been displayed (step S221: NO), the fatigue data acquisition unit 101 waits until the fatigue data acquisition unit 101 determines that the at least one second still image has been displayed.

In step S222, the fatigue data acquisition unit 101 acquires the fatigue data.

In step S223, the parallax adjustment value data acquisition unit 102 acquires the parallax adjustment value data indicating the parallax adjustment value calculated on the basis of the content recorded in the recording unit 104.

In step S224, the parallax adjustment unit 103 adjusts the parallax of the image on the basis of the parallax adjustment value indicated by the parallax adjustment value data acquired in step S223.

The image generation device and image generation program according to the embodiment have been described above. The image generation device 10 acquires the fatigue data indicating the information on the fatigue of the viewer. The parallax adjustment value data acquisition unit 102 calculates the parallax adjustment value data including the parallax adjustment value on the basis of the fatigue data. The parallax adjustment unit 103 adjusts the parallax of the image on the basis of the parallax adjustment value. Specifically, the image generation device 10 decreases the stereoscopic effect of the image displayed on the display 20 when the degree of fatigue of the viewer is higher, and increases the stereoscopic effect of the image displayed on the display 20 when the degree of fatigue of the viewer is lowered. This makes it possible for the image generation device 10 to adjust the stereoscopic effect of at least one of the moving image and the still image to make it difficult to fatigue the viewer.

Furthermore, the image may be the first still image constituting the moving image or the second still image displayed after the first still image. In this case, the image generation device 10 acquires the fatigue data that is generated each time at least one first still image is displayed. Next, the image generation device 10 acquires the parallax adjustment value data each time the at least one first still image is displayed and the fatigue data is acquired. Next, the image generation device 10 records the fatigue data and the parallax adjustment value data in association with each other each time the at least one first still image is displayed and the fatigue data is acquired. When the at least one second still image is displayed and the fatigue data is acquired, the image generation device 10 acquires the parallax adjustment value data indicating the parallax adjustment value that is used to adjust the parallax of the second still image and calculated on the basis of the content recorded in the recording unit 104.

This makes it possible for the image generation device 10 to adjust a stereoscopic effect of the at least one of the moving image and the still image on the basis of a record of the degree of fatigue when the viewer views the first scene including the first still image. Therefore, the image generation device 10 can adjust the stereoscopic effect of the at least one of the moving image and the still image to make it difficult to further fatigue the viewer.

In the above-described embodiment, a case where the detection device 30 is a camera and the movement of the pupil of the viewer viewing the image is filmed has been described as an example, but the present invention is not limited thereto. When the detection device 30 is the camera, the camera may film a skin of the viewer, an action of the viewer, and the like.

When the skin of the viewer is being filmed, the parallax adjustment value is calculated on the basis of change over time in color of the skin of the viewer appearing in the at least one of the moving image and the still image.

Further, when the action of the viewer is being filmed, the parallax adjustment value is calculated by applying machine learning to the action of the viewer appearing in the at least one of the moving image and the still image.

Further, in the embodiment described above, the case where the detection device 30 is the camera has been described as an example, but the present invention is not limited thereto. For example, the detection device 30 may be a pulse sensor, an electroencephalogram sensor, or a saliva sensor. Further, when the detection device 30 is the pulse sensor, the parallax adjustment value data acquisition unit 102 may acquires parallax adjustment value data indicating a parallax adjustment value calculated by using heart rate variability (HRV) analysis.

However, it is preferable for the detection device 30 to be able to collect the fatigue data without coming into contact with the viewer. That is, it is preferable for the fatigue data acquisition unit 101 to acquire the fatigue data generated using a sensor that does not come into contact with the viewer. This makes it possible for the image generation device 10 to acquire the fatigue data without bothering the viewer.

Furthermore, in the above-described embodiment, a case where functions of the image generation device 10 illustrated in FIG. 2 are realized by the processor 11 that reads and executes the image generation program has been described, the present invention is not limited thereto.

At least some of the functions of the image generation device 10 illustrated in FIG. 2 may be realized by hardware including circuitry such as a large scale integration (LSI), an application specific integrated circuit (ASIC), a field-programmable gate array (FPGA), or a graphics processing unit (GPU). Alternatively, at least some of the functions of the image generation device 10 illustrated in FIG. 2 may be realized by cooperation of software and hardware.

Furthermore, in the above-described embodiment, a case where the relationship between the degree of fatigue of the viewer and the parallax adjustment value is illustrated in FIG. 3 and Equation (1) has been described as an example, but the present invention is not limited thereto. The parallax adjustment value may decrease when the degree of fatigue of the viewer is higher, and increase when the degree of fatigue of the viewer is lower.

Furthermore, when the fatigue data indicates that the degree of fatigue of the viewer changes in excess of a predetermined threshold value within a predetermined time, the parallax adjustment value data acquisition unit 102 acquires the parallax adjustment value data for making an amount of change in parallax of the image per unit time equal to or smaller than a predetermined amount of change. This makes it possible for the image generation device 10 to avoid a situation in which the viewer becomes fatigued by suddenly changing the parallax of the image due to a sudden change in the degree of the fatigue of the viewer.

Furthermore, the image generation device 10 acquires the fatigue data from each of a plurality of viewers who have viewed at least one first still image. The image generation device 10 acquires parallax adjustment value data indicating a parallax adjustment value calculated on the basis of the fatigue data acquired from each of the plurality of viewers who have viewed the at least one first still image. Such a parallax adjustment value is, for example, a statistical value such as an average of parallax adjustment values calculated from the respective fatigue pieces of data acquired from the plurality of viewers. This makes it possible for the image generation device 10 to adjust the stereoscopic effect of the at least one of the moving image and the still image to make it less fatiguing for a viewer even when a plurality of viewers view the image at the same time in a movie theater or the like.

Furthermore, in the embodiment described above, a case where the first still image and the second still image constitute the same moving image has been described as an example, but the present invention is not limited thereto. The image generation device 10 may also execute the above-described processing even when the first still image is a still image constituting a first moving image and the second still image is a still image constituting the second moving image different from the first moving image. Furthermore, this makes it possible for the image generation device 10 to adjust the stereoscopic effect of the at least one of the moving image and the still image to make it difficult to fatigue the viewer on the basis of the degree of fatigue when the viewer has viewed the image in the past.

Although the embodiment of the present invention has been described above in detail with reference to the drawings, a specific configuration is not limited to the embodiment, and at least one of various combinations, modifications, substitutions, and design changes may be made without departing from the gist of the present invention.

Further, the effects of the embodiment of the present invention described above are effects shown as an example. Therefore, the embodiment of the present invention can have other effects that can be recognized from the description of the embodiment described above by those skilled in the art, in addition to the effects described above.

### Industrial Applicability

The image generation device of the present embodiment can be used in industries in the field where it is necessary to provide at least one of a stereoscopic moving image and a still image in which it is difficult to fatigue the viewer.

### REFERENCE SIGNS LIST

10 Image generation device
11 Processor
12 Main storage device
13 Communication interface
14 Auxiliary storage device
15 Input and output device
16 Bus
20 Display
30 Detection device
101 Fatigue data acquisition unit
102 Parallax adjustment value data acquisition unit
103 Parallax adjustment unit
104 Recording unit

What is claimed is:

1. An image generation device comprising:
a fatigue data acquisition unit configured to acquire fatigue data indicating information on fatigue, the fatigue data including at least a fatigue degree of a viewer;
a parallax adjustment value data acquisition unit configured to calculate parallax adjustment value data including a parallax adjustment value on the basis of the fatigue data; and
a parallax adjustment unit configured to adjust a parallax of an image on the basis of the parallax adjustment value, wherein
the parallax adjustment value data acquisition unit acquires the parallax adjustment value data indicating the parallax adjustment value for making an amount of change in parallax of the image per unit time equal to or smaller than a predetermined amount of change when the fatigue data indicates that the fatigue degree of the viewer changes in excess of a predetermined threshold within a predetermined time.

2. The image generation device according to claim 1, further comprising:
a recording unit in which the fatigue data and the parallax adjustment value data are recorded in association with each other, wherein
the fatigue data acquisition unit acquires first fatigue data when a first still image in a moving image has been displayed, and acquires second fatigue data when a second still image displayed after the first still image is displayed, and
the parallax adjustment value data acquisition unit acquires the first fatigue data and the second fatigue data from the fatigue data acquisition unit, acquires the parallax adjustment value data corresponding to the fatigue data from the recording unit, and adjusts a parallax of an image to be displayed, from the first acquired fatigue data and the second acquired fatigue data and the parallax adjustment value based on the parallax adjustment value data.

3. The image generation device according to claim 2, wherein
the fatigue data acquisition unit acquires the fatigue data from each of a plurality of viewers who have viewed a still image in a moving image, and
the parallax adjustment value data acquisition unit acquires the parallax adjustment value data indicating the parallax adjustment value calculated on the basis of the fatigue data acquired from each of the plurality of viewers who have viewed the still image in the moving image.
